(19) United States
(12) Patent Application Publication
(10) Pub. No.: US 2014/0161328 A1
(43) Pub. Date: Jun. 12, 2014

(54) System and Method for Automatically Selecting a Condom Size from a Picture Reference

(71) Applicants: Jud Ireland, Miami Beach, FL (US); Adam Glickman, Los Angeles, CA (US); Patrick Bretagna, Los Angeles, CA (US); Li Wang, Los Angeles, CA (US)

(72) Inventors: Jud Ireland, Miami Beach, FL (US); Adam Glickman, Los Angeles, CA (US); Patrick Bretagna, Los Angeles, CA (US); Li Wang, Los Angeles, CA (US)

(21) Appl. No.: 14/104,474

(22) Filed: Dec. 12, 2013

Related U.S. Application Data
(60) Provisional application No. 61/736,251, filed on Dec. 12, 2012.
(60) Provisional application No. 61/874,475, filed on Sep. 6, 2013.

(51) Int. Cl. G06K 9/62

(52) U.S. Cl. CPC G06K 9/6202
USPC 382/128

(57) ABSTRACT

A system and method of selecting a prophylactic for a body part, such as a condom for a penis. The system is run as a software application running on a handheld electronic device that contains an integrated digital camera. To operate the software application, a user selects a measurement standard having known dimensions. The measurement standard is positioned near the body part and a digital image is taken. Points along the periphery of the imaged body part are manually selected. From the selected points, the software application can calculate the distance between the points and size the body part. In the case of a penis, the length and girth of the penis can be readily calculated by the software application. Once the body part is sized, the software application uses the measured sizes to determine what prophylactic device would fit best. This information is communicated to the user.

### RELATED APPLICATIONS

This application claims priority of both U.S. Provisional Patent Application No. 61/874,475 filed Sep. 6, 2013 and U.S. Provisional Patent Application No. 61/736,251 filed Dec. 12, 2012.

### BACKGROUND OF THE INVENTION

1. Field of the Invention

In general, the present invention relates to systems and methods for measuring a penis for the purpose of properly sizing a condom. More particularly, the present invention relates to systems and methods that size a penis from a digital picture taken of the penis.

2. Prior Art Description

People come in a large variety of sizes and shapes. However, most commercial brands of condoms do not. Rather, most commercial condoms are manufactured in only one or two sizes. As a consequence, commercial condoms are too large for some people and too small for others. Commercial condoms only properly fit the minority of people who happen to have a statistically average penis size.

If a condom is too large, it does not seal well against the skin. This can cause a condom to leak or slip off during use. As such, overly large condoms cannot perform their primary function of being a prophylactic.

Condoms that are too small are uncomfortable to wear. A small condom can restrict blood flow, therein making an erection smaller and shorter in duration. Furthermore, condoms that are too small are far more likely to break than condoms that are properly fit.

There are some condom manufacturers that make condoms in a wide range of sizes. The problem that occurs during marketing is that the majority of men do not know the actual size of their erect penis. As such, they do not know what size condom to purchase when given the choice.

Condom manufacturers recognize that in order to sell sized condoms, customers must be educated on how to accurately measure their penises. When measuring a penis, the two dimensions needed to properly size a condom are penis length and penis diameter, or girth. In the past, these measurements can be taken manually using a flexible tape measure or a string and ruler. However, such measurements can be difficult to make. This leads to many inaccurate measurements and consequently, poor fitting condoms.

Using modern technology, smart phone software applications have been developed that enable a person to obtain dimensions of a penis by imaging the penis with the digital camera function of a smart phone. Such software applications are exemplified by U.S. Patent Application Publication No. 2012/0191013 to Nelson, entitled System To Select Condom Using Hand Held Electronic Measuring Device. The problems with such prior art systems are twofold. First, such systems require that the electronic smart phone be brought into very close proximity with the penis so that the penis is the primary object in the digital camera's field of view. Second, the system requires that two reference photographs be taken; one from above and one from the side. The two reference photographs are needed to determine variables, such as the angle of the penis relative the camera. The images taken by the camera are often compromised by the presence of hair or background objects, such as a thigh or hand, that are nearly identical in color as the penis. As such, prior art electronic systems have great difficulty in isolating the part of an image that represents the true periphery of the penis. The inability to accurately identify the periphery of the penis produces many false readings. False readings can result in poor condom size recommendations. Poor condom size recommendations may result in legal liabilities for the company promoting the software application.

A need therefore exists for a software application that can be used to accurately and reliably measure the length and girth of a penis using a single digital photograph taken at a comfortable distance from the penis. A need also exists for a software application that can automatically and accurately select a condom size appropriate and safe for the penis that is electronically measured. These needs are met by the present invention as described and claimed below.

### SUMMARY OF THE INVENTION

The present invention is a system and method of selecting a prophylactic for a body part, such as a condom for a penis. The system is run as a software application running on a handheld electronic device that contains an integrated digital camera.

To operate the software application, a user selects a measurement standard having known dimensions. For example, a user can select a credit card, which is known to be 3⅜ inches by 2⅛ inches. The measurement standard is positioned near the body part to be imaged. The measurement standard and the body part are imaged with the digital camera to produce a digital image that is dimensionally scaled with reference to the measurement standard.

Points along the periphery of the imaged body part are manually selected. From the selected points, the software application can calculate the distance between the points and size the body part. In the case of a penis, the length and girth of the penis can be readily calculated by the software application.

Once the body part is sized, the software application uses the measured sizes to determine what prophylactic device would fit best. This information is communicated to the user. Furthermore, the user can be automatically linked to a retail site that sells the prophylactic of the proper size.

Consequently, using a single digital image, a user can quickly and easily order prophylactics that are properly sized for that user.

### BRIEF DESCRIPTION OF THE DRAWINGS

For a better understanding of the present invention, reference is made to the following description of an exemplary embodiment thereof, considered in conjunction with the accompanying drawings, in which:

FIG. 1 is a schematic of the physical components required to operate an exemplary embodiment of the present invention;

FIG. 2 is an exemplary embodiment of a digital image produced by the present invention;

FIG. 3 is a block flow diagram showing an exemplary method of operation for the present invention;

FIG. 4 is the digital image of FIG. 2 superimposed with vertical selection lines; and

FIG. 5 is the digital image of FIG. 2 superimposed with horizontal selection lines.

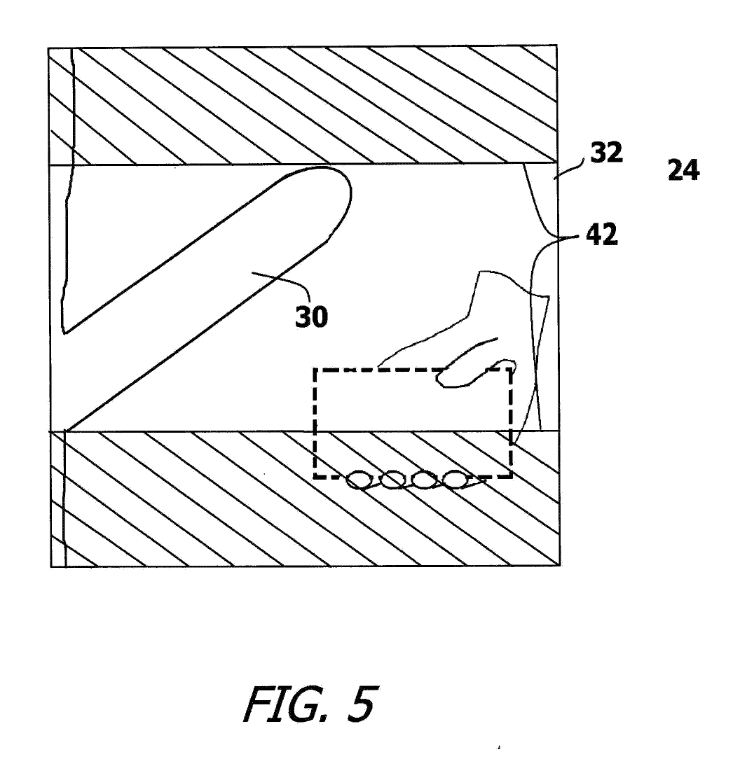

### DETAILED DESCRIPTION OF THE DRAWINGS

Although the present invention software application can be run by many handheld electronic devices, such as tablet computers and laptop computers, the software application is particularly well suited for use with smart phones that contain integrated digital cameras. Accordingly, in the illustrations provided, a hand held smart phone is shown. This exemplary embodiment is selected in order to set forth the best mode contemplated for the invention. The illustrated embodiment, however, is merely exemplary and should not be considered a limitation when interpreting the scope of the appended claims.

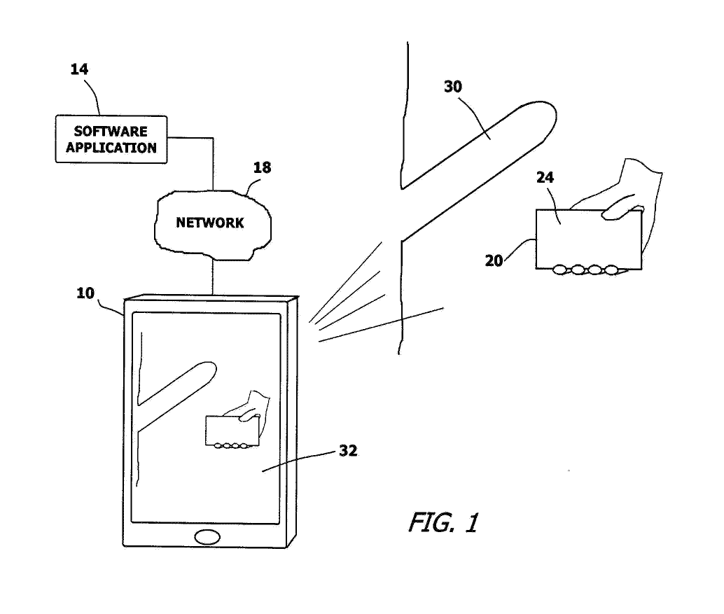

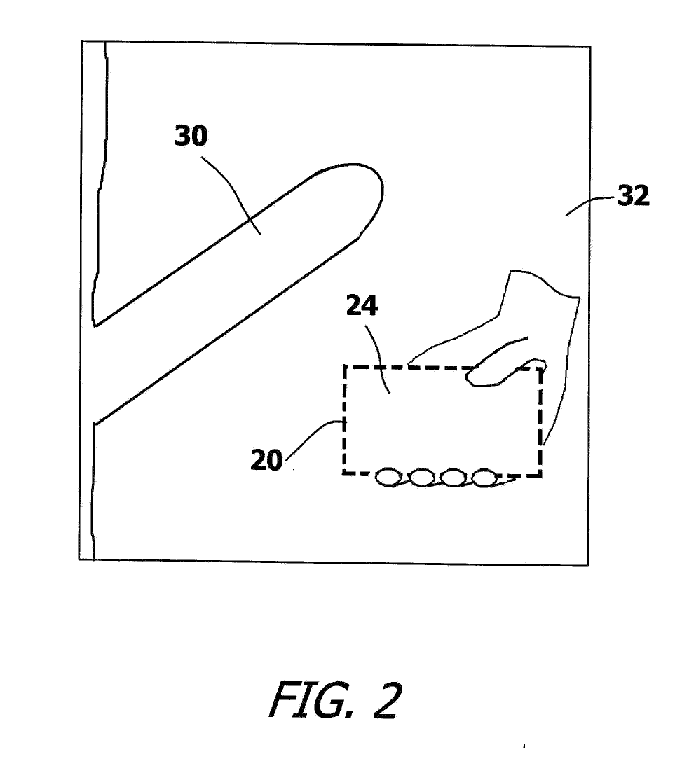

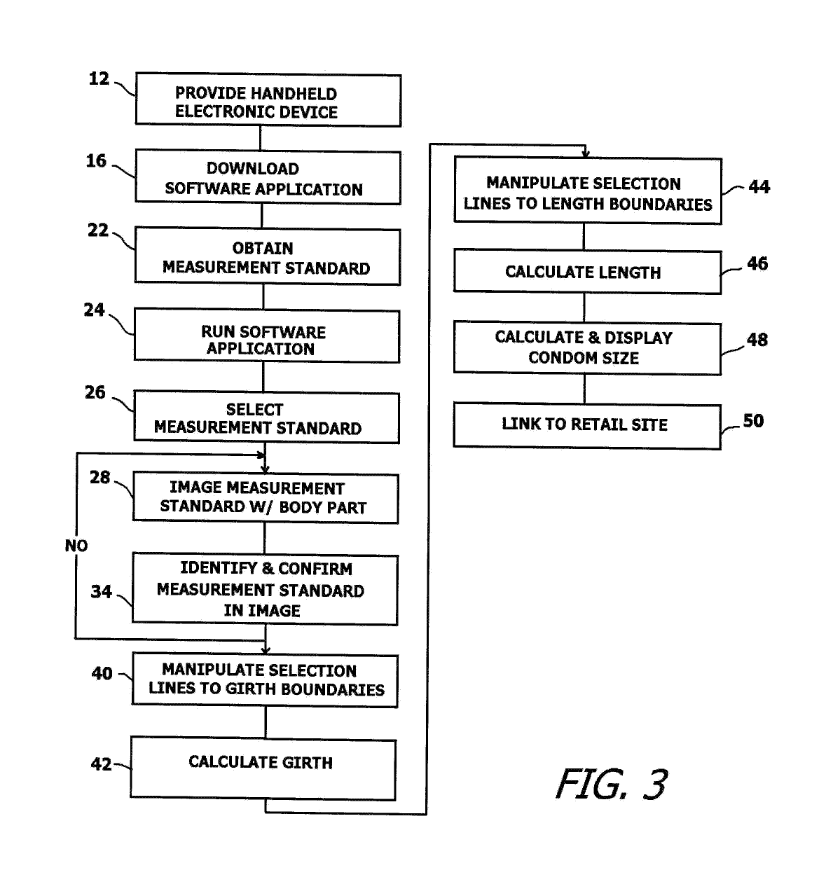

The purpose of the present invention system and method is to properly measure a body part, such as the penis, and identify the properly sized prophylactic for that body part in a manner that is both easy and accurate. Referring initially to FIG. 1 in conjunction with both FIG. 2 and FIG. 3, the methodology utilized by the present invention can begin to be explained. A handheld electronic device 10, such as smart phone, is provided that contains a digital camera. See Block 12. A software application 14 is downloaded into the operational software of the handheld electronic device 10. See Block 16. The software application 14 is downloaded using either the worldwide web or a cellular phone network 18. Once the software application 14 is loaded into the handheld electronic device 10, the handheld electronic device 10 is ready for use.

Prior to the running of the software application 14, a user must obtain a measurement standard 20 that can be recognized by the software application 14. See Block 22. The measurement standard 20 can be a credit card, a compact disc, a dollar bill, or any other commonly available standard sized object recognized as an acceptable option by the software application 14. In the exemplary embodiment illustrated, the measurement standard is a credit card 24.

As is indicated by Block 24, once the user's penis is at full arousal, the software application 14 is run by the handheld electronic device 10. The user then selects the measurement standard intended to be used from a selection menu offered by the software application 14. See Block 26. For the purposes of illustration and description, the selected measurement standard 20 is a credit card 24. However, as previously mentioned, any object having known dimensions, such as paper money, coin money, and CDs can also be offered in the selection menu.

The measurement standard 20 is manually held in the same plane as the penis 30. The penis 30 and measurement standard 20 are then imaged together using the digital camera of the handheld electronic device 10. Accordingly, the software application 14 being run by the handheld electronic device 10 now has access to a digital image 32 of both the penis 30 and the measurement standard 20. See Block 28.

The software application 14 identifies the measurement standard 20 in the digital image 32. See Block 34. The measurement standard 20 is outlined by the software application 14 and presented to the user for confirmation. Once the user confirms the measurement standard 20, the software application 14 now knows the scale of the digital image 32. If the software application 14 cannot identify the measurement standard 20 in the digital image 32, then the user is prompted to take another image. Once the measurement standard 20 is recognized in the digital image 32, the digital image 32 is scaled. The software application 14 can accurately measure distances between points in the plane of the imaged penis 30. The software application 14 can also assign size values to pixels and groupings of pixels within the digital image 32.

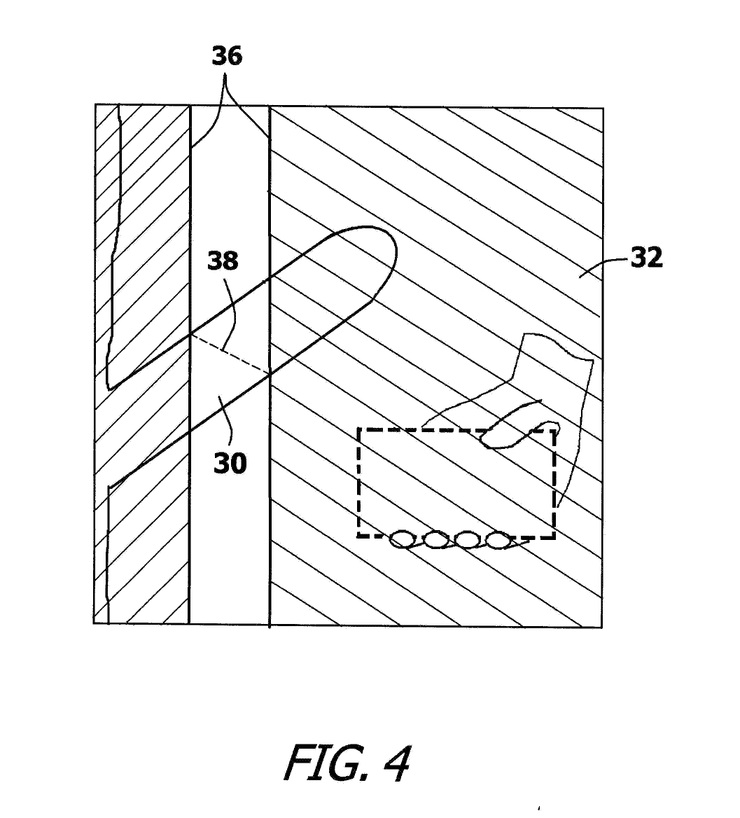

Referring to FIG. 4 in conjunction with FIG. 2 and FIG. 3, it can be seen that the user is presented with the digital image 32. Vertical selection lines 36 are provided that are superimposed over the digital image 32. The position of the vertical selection lines 36 can be selectively adjusted by the user. The user is prompted to manipulate the vertical selection lines 36 so that they contact opposite sides of the penis 30 that are separated by an imaginary line 38. See Block 40. By manually moving the vertical selection lines to the side edges of the penis 30, the software application 14 does not have to distinguish the peripheral edges of the penis 30 in the digital image 32 from the background imagery. This eliminates many of the imaging errors inherent in prior art systems. Rather, by having the user move the vertical selection lines 36 to the side edges of the penis 30, it can be accurately assumed that the entire area along the imaginary line 38 between the vertical selection lines 36 is occupied by the penis 30. The software application 14 can then calculate the girth of the penis 30 and can assign a measurement value to that girth using the dimensions of the measurement standard 20 as a ruler. See Block 42.

Once the girth of the penis 30 is calculated, the length of the penis 30 is determined in a similar manner. The user is presented with the same digital image 32 of the penis 30. Horizontal selection lines 44 are provided that are superimposed over the digital image 32. The position of the horizontal selection lines 44 can be selectively adjusted by the user. The user is prompted to manipulate the horizontal selection lines 44 so that they align with the tip of the penis 30 and the base of the penis 30. See Block 46. By manually moving the horizontal selection lines 44 to the tip and base of the penis 30, the software application 14 does not have to automatically identify the beginning and the end of the penis 30 in the digital image 32. This also eliminates many of the imaging errors inherent in prior art systems. Rather, by having the user move the horizontal selection lines 44 to the base and tip of the penis 30, the overall length of the penis 30 can be extrapolated. See Block 46.

Once both the length and girth of the penis 30 are measured from the digital image 32, the software application 14 automatically cross-references the dimensions within a size database and determines what size condom is proper for the penis 30 imaged. The size of the condom is displayed on the handheld electronic device 10. Furthermore, the user is automatically linked with a retail website where condoms of that size can be ordered. See Block 50.

It will be understood, that the embodiment of the present invention that is illustrated and described is merely exemplary and that a person skilled in the art can make many variations to that embodiment. All such embodiments are intended to be included within the scope of the present invention as defined by the claims.

What is claimed is:

1. A method of selecting a condom for a user's penis, said method comprising the steps of:
selecting a measurement standard having known dimensions;
positioning said measurement standard proximate a penis;
imaging said measurement standard and said penis with a digital camera to produce a digital image of said penis that is dimensionally scaled relative said measurement standard;
manually selecting points in said digital image corresponding to a tip, a base and sides of said penis;
calculating a penis length and a penis girth from said points; and
calculating a proper condom size for said penis length and said penis girth.

2. The method according to claim 1, wherein said digital camera is integrated into a handheld electronic device that runs a software application, wherein said software application is capable of performing said step of calculating said penis length and said penis girth from said points.

3. The method according to claim 2, wherein said software application is capable of performing said step of calculating said proper condom size for said penis length and said penis girth.

4. The method according to claim 2, wherein said handheld electronic device is selected from a group consisting of smart phones, tablet computers and laptop computers.

5. The method according to claim 1, further including the step of linking said user to a retail site that sells condoms of said proper condom size.

6. The method according to claim 1, wherein said step of selecting a measurement standard includes selecting a measurement standard from a group consisting of credit cards, CDs, paper money and coined money.

7. The method according to claim 1, wherein said step of manually selecting points in said digital image corresponding to a tip, a base and sides of said penis, includes manipulating vertical selection lines over said digital image to points on opposite side edges of said penis.

8. The method according to claim 1, wherein said step of manually selecting points in said digital image corresponding to a tip, a base and sides of said penis, includes manipulating horizontal selection lines over said digital image to points on said base and said tip of said penis.

9. A method of selecting a properly sized condom for a penis, said method comprising the steps of:
taking a digital image of a penis using a handheld electronic device that is running a software application, wherein said digital image of said penis includes a base, a tip and side edges;
utilizing said handheld electronic device and said software application to manually select points within said digital image of said penis that correspond in position to said tip, said base and said side edges;
utilizing said software application to calculate a penis length and a penis girth from said points; and
utilizing said software application to calculate a properly sized condom for said penis length and said penis girth.

10. The method according to claim 9, further including the step of selecting a measurement standard having known dimensions.

11. The method according to claim 10, further including the step of positioning said measurement standard proximate said penis prior to said step of taking said digital image, wherein said measurement standard appears in said digital image.

12. The method according to claim 11, wherein said software application determines pixel size within said digital image from said measurement standard in said digital image.

13. The method according to claim 9, wherein said handheld electronic device is selected from a group consisting of smart phones, tablet computers and laptop computers.

14. The method according to claim 9, further including the step of linking said user to a retail site that sells condoms of said properly sized condom.

15. The method according to claim 9, wherein said step of selecting a measurement standard includes selecting a measurement standard from a group consisting of credit cards, CDs, paper money and coined money.

16. The method according to claim 9, wherein said step of utilizing said handheld electronic device and said software application to manually select points within said digital image of said penis that correspond in position to said tip, said base and said side edges includes manipulating vertical selection lines over said digital image to points on said side edges of said penis.

17. The method according to claim 9, wherein said step of utilizing said handheld electronic device and said software application to manually select points within said digital image of said penis that correspond in position to said tip, said base and said side edges includes manipulating horizontal selection lines over said digital image to points on said base and said tip of said penis.

18. A method of selecting a prophylactic for a body part, said method comprising the steps of:
taking a digital image of said body part using a handheld electronic device that is running a software application, wherein said digital image shows at least some peripheral edges of said body part;
utilizing said handheld electronic device and said software application to manually select points within said digital image that lay along said peripheral edges;
utilizing said software application to calculate distances between said points selected, therein determining a size for said body part; and
utilizing said software application to calculate a properly sized prophylactic for said body part of said size.

19. The method according to claim 18, further including the step of selecting a measurement standard having known dimensions.

20. The method according to claim 19, further including the step of positioning said measurement standard proximate said body part prior to said step of taking said digital image, wherein said measurement standard appears in said digital image.
